(19) United States
(12) Patent Application Publication
(10) Pub. No.: US 2015/0033242 A1
(43) Pub. Date: Jan. 29, 2015

(54) Method for Automatic Parallel Computing

(71) Applicant: Andriy Michailovich Stepanchuk, Wappingers Falls, NY (US)

(72) Inventor: Andriy Michailovich Stepanchuk, Wappingers Falls, NY (US)

(21) Appl. No.: 13/952,844

(22) Filed: Jul. 29, 2013

(51) Int. Cl. G06F 9/46

(52) U.S. Cl. CPC G06F 9/46
USPC 718/107

(57) ABSTRACT

A method for automatic task-level parallelization of execution of a computer program with automatic concurrency control. According to this invention, shared data in memory must be queried. Such memory queries represent side-effects of their enclosing tasks and allow determining how tasks must be executed with regard to each other based on intersections of their queried data. Tasks that have intentions to modify the same data (their side-effects intersect) must be executed sequentially; otherwise, tasks can be executed in parallel.

### FIELD OF THE INVENTION

This invention relates to the field of computational models, and more specifically to the parallel execution of a computer program, and to a method for automatic task-level parallelization and concurrency control.

### BACKGROUND OF THE INVENTION

Given the increasing number of processing elements of computing devices, it becomes apparent that the mainstream sequential computational model is not well-suitable to create computer programs that take advantage of the underlying processing capabilities. Multiple processing elements on a single computing device require highly parallel computing; therefore, highly parallel computing is moving from a scientific discipline of a few skilled software engineers to mainstream software development. Though declarative languages (functional and other computational models) perhaps are more suitable for highly parallel computing and more popular among scientific community, many real-life applications are naturally represented by imperative programs; thus, most professional programmers in mainstream software development choose imperative languages.

In essence, parallel computing is composed of tasks to be executed in parallel, where a task is a unit of computation. Programmers need the ability to define, start/stop, and coordinate parallel tasks. While a significant progress is done in compilers for automatic data-level parallelization (in which the same operation is performed on many data elements by many processing elements at the same time), task-level parallelization is still done manually. Task-level parallelization refers to operations that are grouped in tasks and performed on the same or different data by many processing elements at the same time. Known systems and methods require defining boundaries of tasks and using various concurrency control mechanisms by programmers explicitly. As a result, it becomes more difficult to ensure efficient parallel execution on a large number of processing elements, including automatic scalability for the increasing number of processing elements.

### SUMMARY OF THE INVENTION

This invention provides a method for automatic task-level parallelization of execution of a computer program with automatic concurrency control. The method frees an application programmer from details of such parallelization. As a result, embodiments of this invention would allow making efficient and scalable parallel execution of a computer program regardless of skills of an application programmer.

This invention primarily addresses data access mechanism. According to this invention, shared data in memory must be queried. Such memory queries represent side-effects of their enclosing tasks and allow determining how tasks must be executed with regard to each other based on intersections of their queried data. Tasks that have intentions to modify the same data (their side-effects intersect) must be executed sequentially; otherwise, tasks can be executed in parallel. The term “task” as used herein refers to a function, method, procedure, etc. This invention does not change the sequential programming model but rather enhances it with intrinsic parallelism.

The object of this invention is to define a method for automatically parallel computer programs. The main advantages of this invention are portability and ease of use. The advantages occur due to the declarative way of memory access. Such high-level abstraction allows providing efficient parallel execution of a computer program with compilers and run-time libraries which embody this invention. Embodiments of this invention in languages, compilers, and run-time libraries would vary in forms based on a variety of computing platforms and programming languages.

### BRIEF DESCRIPTION OF THE DRAWINGS

FIG. 1 illustrates a computer program and shared data access.

FIG. 2 illustrates queues of tasks based on intersection of their data sets.

FIG. 3 illustrates executions of tasks from queues.

FIG. 4 illustrates states of a queue.

FIG. 5 illustrates task scheduling.

### DETAILED DESCRIPTION OF THE INVENTION

Here I disclose a general method for automatic task-level parallelization of execution of a computer program with automatic concurrency control. Embodiments of this invention include programming languages, compilers, and run-time libraries.

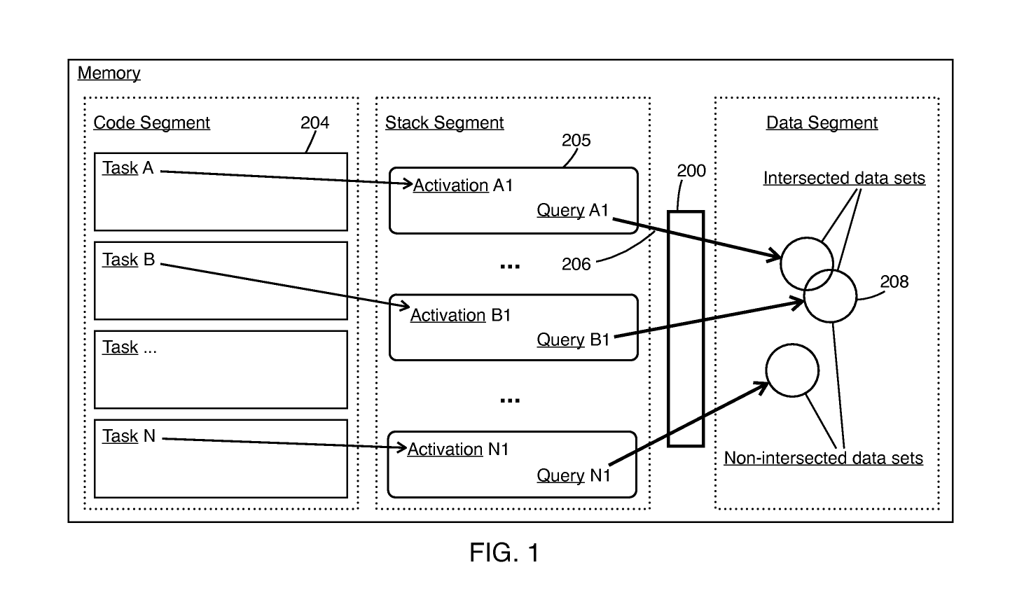

In general, as illustrated on FIG. 1, a computer program is composed of tasks 204. A task is a sequence of instructions to be executed as a unit. A task can be represented as a subprogram, routine, subroutine, procedure, function, or method. Tasks perform data manipulations and computations. Some data are local, they are created and destroyed on stack within a lifetime of a task activation 205. Other data are shared 208 and must persist in memory beyond a lifetime of a task activation 205. The traditional programming model relies on global variables and collections to store references (pointers) to shared data. The term “global variables” as used herein refers to static variables or variables declared outside of a task. Shared data as well as global variables represent a state of a computer program and, in parallel execution, can be created, read, updated, and deleted by several tasks at the same time. Given shared data and global variables are freely accessed by tasks, the traditional programming model depends on a programmer to apply an appropriate data access control mechanism to avoid modifications of the same data at the same time.

According of this invention, a task queries memory 206 to get references (pointers) to shared data 208 instead of using global variables and collections. Said memory query defines shared data to be processed by a task and an intention to read or modify the data. A result of said memory query is local variables and collections that store references (pointers) to the queried data in memory or to a copy of the queried data. Said references (pointers) are only valid within a lifetime of a task activation 205 which queried memory and safe to use for the intended purpose with disregard to parallel execution of other tasks of a computer program. If data are queried for read-only access, then the data are safe to be read; and if data are queried for writable access, then the data are safe to be created, updated, or deleted as well as to be read. The term “memory query” as used herein refers to an application programming interface of a run-time library 200 to create, read, update, or delete shared data 208 in memory. The run-time library 200 plays roles of a memory manager and task scheduler.

Using a language-independent notation and for the illustration purpose only, the following illustrates this invention in comparison with the traditional programming model. In the traditional programming model, function A creates an instance of data structure Foo and assigns it to global variable G, then functions B and C update attribute Y of the instance of data structure Foo in parallel:

| | | |
|---|---|---|
| 1 | FUNC | A |
| 2 | | G := new Foo |
| 3 | END | |
| 1 | FUNC | B |
| 2 | | G.Y = 1 |
| 3 | END | |
| 1 | FUNC | C |
| 2 | | G.Y = 2 |
| 3 | END | |

Thus, in the traditional programming model, it is responsibility of a programmer to use an appropriate concurrency control mechanism to prevent the concurrent modification of attribute Y. On the contrary, this invention proposes to query memory:

| | | |
|---|---|---|
| 1 | FUNC | A |
| 2 | | q := YIELD Foo |
| 3 | | f := q.insert |
| 4 | | f.X = 3 |
| 5 | | END |
| 1 | FUNC | B |
| 2 | | q := YIELD Foo WHERE X = 3 |
| 3 | | f := q.first |
| 4 | | f.Y = 1 |
| 5 | | END |
| 1 | FUNC | C |
| 2 | | q := YIELD Foo WHERE X = 3 |
| 3 | | f := q.first |
| 4 | | f.Y = 2 |
| 5 | END | |

where q and f are local variables, YIELD queries memory for writable access. According to this invention, the run-time library 200 will execute the memory query of function C when function B is complete, or in reverse bases on FIFO scheduling. Therefore, it frees a programmer from handling the concurrency manually. Moreover, it deduces boundaries of the tasks automatically: from the memory queries to the end of their enclosing functions.

This invention distinguishes said memory query for read-only access from said memory query for writable access. Using a language-independent notation and for the illustration purpose only, the following memory query illustrates said memory query for read-only access:

### q :=SELECT Foo WHERE X=3

, and the following memory query illustrates said memory query for writable access:

### q :=YIELD Foo WHERE X=3

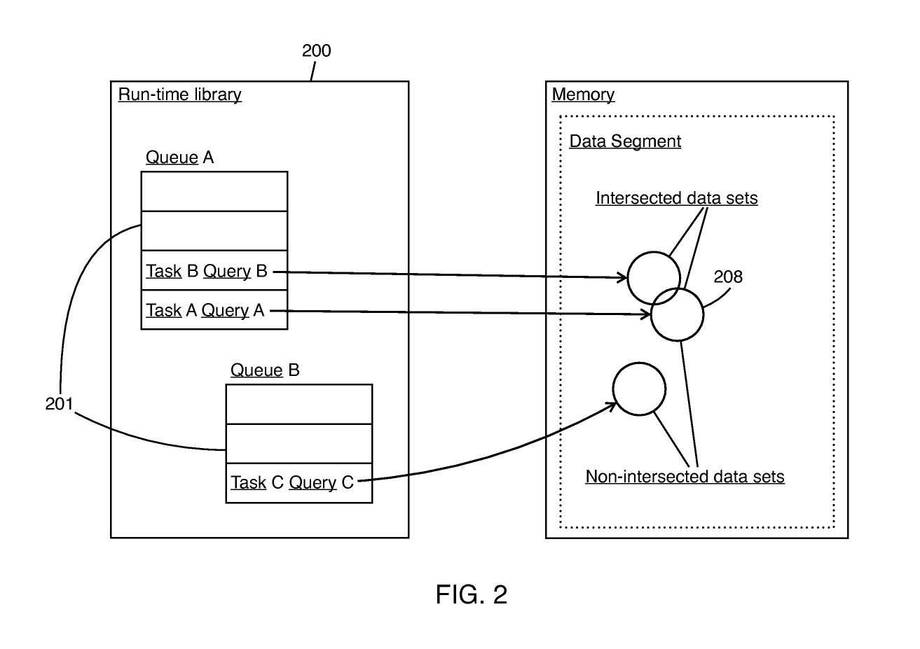

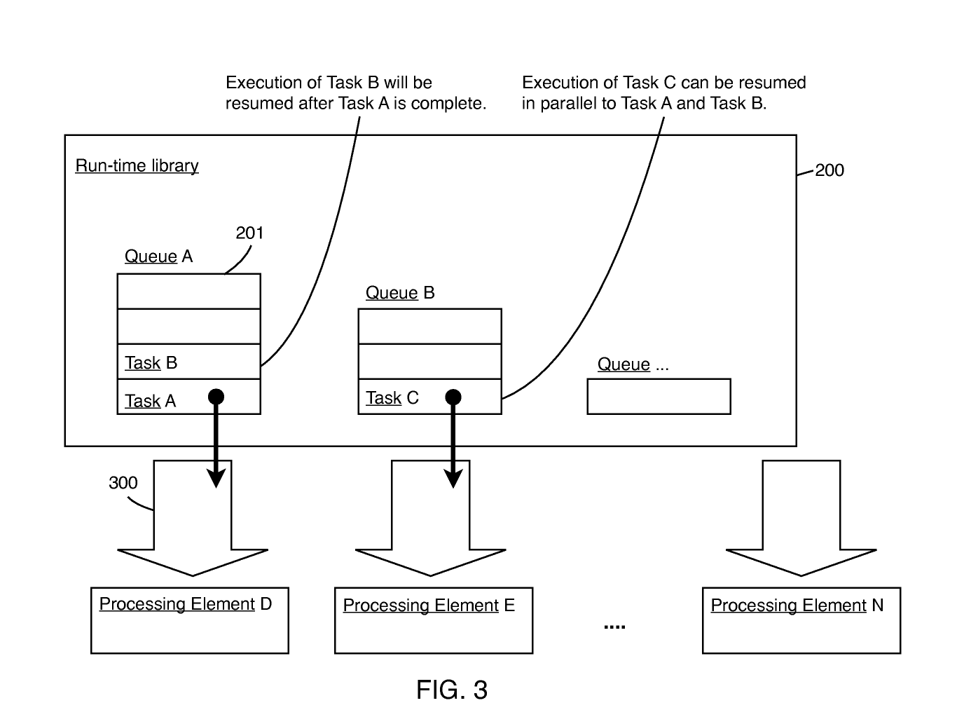

According to this invention, a run-time library 200 which embodies this invention is responsible to handle said memory queries 206. The run-time library forms queues 201 of active tasks with said memory queries which produce intersected data sets as illustrated on FIG. 2. Tasks from different queues are executed in parallel, but tasks within a queue are executed sequentially as illustrated on FIG. 3.

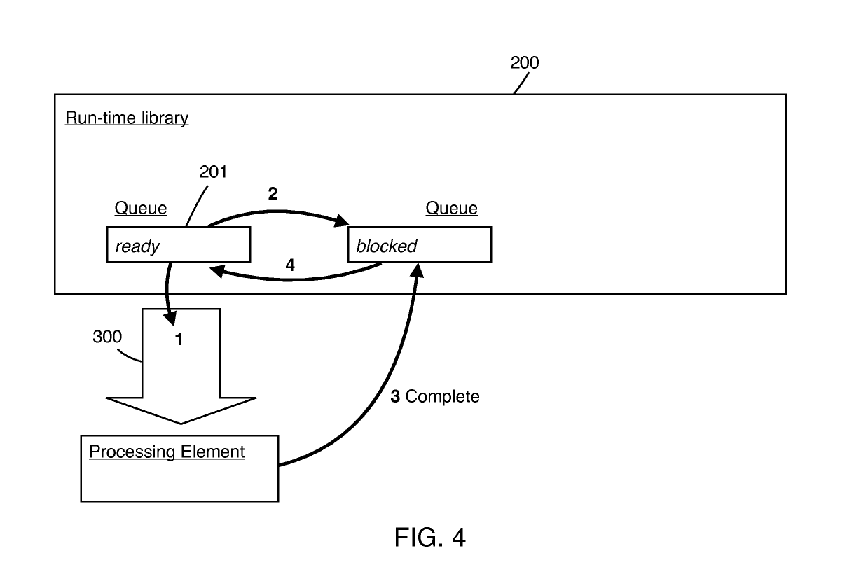

When the run-time library extracts a task from a queue 201 for the execution 300, the run-time library eliminates the queue from the subsequent extraction of its tasks. Such a queue is called blocked. When a task is complete, the run-time library restores the corresponding queue for the subsequent extraction of its tasks. Such a queue is called ready. Thus, as illustrated on FIG. 4, the each queue can be in a ready or blocked state. A queue is in the blocked state if it has an extracted task and is waiting for the task to be completed. Otherwise, a queue is in the ready state. When there are more than one queue is in the ready state, the run-time library employs the first-in, first-out strategy (FIFO) and extracts a task that came earlier. Other strategies can be employed also. For instance, tasks can have priorities.

In another embodiment, the run-time library employs the multiple-read, single-write strategy in which multiple sequential tasks from the same queue with said memory queries for read-only access can be executed in parallel. Then, when the run-time library extracts a task from a queue for the execution, it checks the next task also. Only when the next task is pending with said memory query for writable access, the queue is blocked and eliminated from the subsequent extraction of its tasks.

In another embodiment, the run-time library employs the copy-on-write strategy in which tasks with said memory queries for read-only access can be executed in parallel with tasks with said memory queries for writable access. Then, only when the run-time library extracts a task with said memory query for writable access, the queue is blocked and eliminated from the subsequent extraction of its tasks.

Other embodiments of this invention can use other strategies to form the queues and extract tasks from them. For instance, in another strategy, tasks with said memory queries for read-only access are executed without said queueing and only tasks with said memory queries for writable access are placed in said queues.

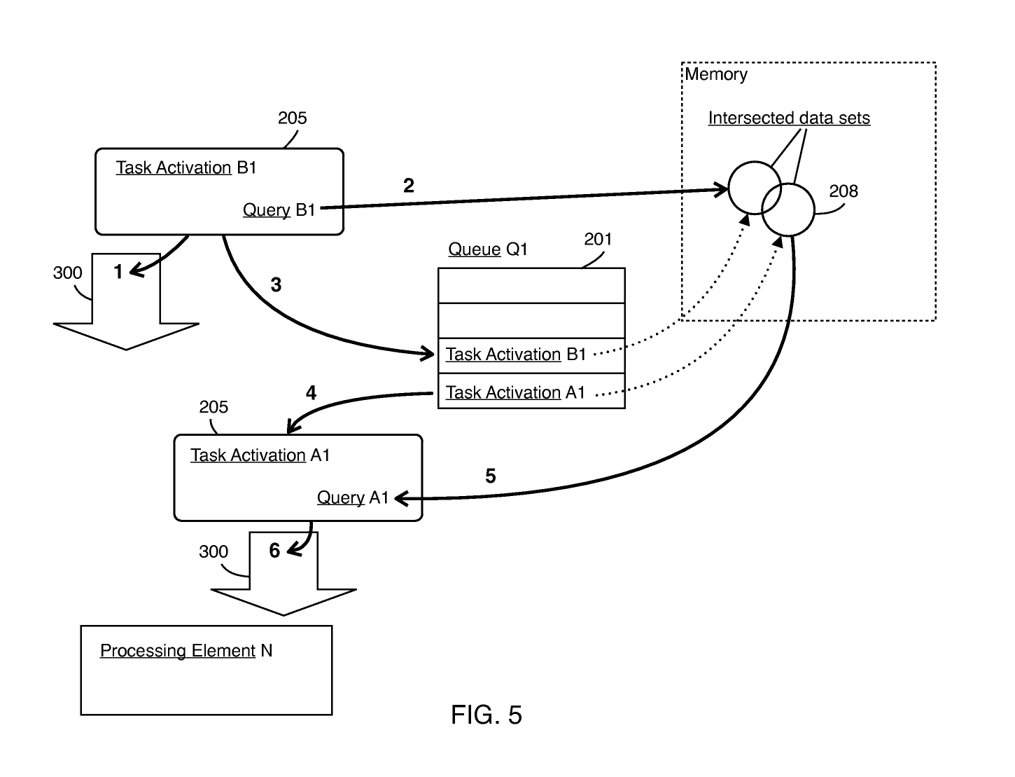

According to this invention, said memory queries are not executed as they are called but scheduled/queued to be executed as illustrated on FIG. 5. At first, the run-time library evaluates a memory query for its potential result data set. At second, the run-time library looks for a queue 201 or queues where the potential result data set intersect 208. At final, the run-time library places a task 205 which owns the memory query into an existing queue or queues if found or into a new queue otherwise. At this moment, the memory query is considered scheduled, execution of the owner task is suspended, and execution of a parent task is resumed. If there is no parent task or the suspended task is not asynchronous, the run-time library extracts the next task 205 from a queue 201 in the ready state and resumes the task execution 300. It is important to note that said memory queries for read-only access can be executed without said scheduling if an embodiment of this invention employs the copy-on-write strategy or similar for shared data modifications.

According to this invention, every task activation has its own stack, and execution of a task can be suspended on one processing element and resumed on another processing element. When execution of a task is resumed, the memory query is executed. A result of the execution is local variables and collections that store references (pointers) to the queried data in memory or to a copy of the queried data (the queried data can be copied to a CPU cache also). The run-time library is responsible for both allocating memory for data and keeping references (pointers) to the allocated data as well as deallocating memory. The run-time library can use any suitable collections to keep the references (pointers): lists, hash-tables, red-black-trees, etc. A programmer is responsible for defining data types. The run-time library uses the definitions as the blueprint for allocating memory for new data and searching existing data by their attributes.

Using a language-independent notation and for the illustration purpose only, the following illustrates a definition of data structure Foo with two attributes X and Y:

| 1 | ENTITY Foo | |
|---|---|---|
| 2 | | X: integer, index |
| 3 | | Y: integer |

| | |
|---|---|
| 4 | END |

This specification does not provide an exact syntax of said memory query and data definition. One skilled in the art can define an exact syntax of said memory query and data definition with relevance to a concrete programming language and an underlying computing platform. A preferred embodiment of this invention is a specialized programming language with a corresponding compiler and run-time libraries. Although, it is to be understood that this invention is not limited to the preferred embodiment and can be embodied into any existing or new programming language without departing from scope of this invention.

I claim:

1. A method for automatic task-level parallelization of execution of a computer program with automatic concurrency control, comprising:
a. providing a run-time library with an application programming interface for the memory queries;
b. using said memory queries to create, read, update, and delete shared data in memory instead of using global variables and collections;
c. grouping enclosing tasks of said memory queries into queues at run time; and
d. extracting tasks from said queues and executing them in parallel.

2. The method of claim 1 wherein said grouping comprises:
a. evaluating said memory queries for their potential result data sets at run time;
b. creating queues of tasks where a queue contains tasks which have said memory queries with intersected potential result data sets; and
c. suspending execution of tasks when they are in said queues.

3. The method of claim 1 wherein said extracting tasks from said queues comprises:
a. determining said queues that are ready for extracting their tasks;
b. extracting a one task from the each determined queue; and
c. resuming execution of the extracted tasks on available processors.

4. The method of claim 3 wherein said determining said queues that are ready for extracting their tasks means said queues that are not waiting for their extracted tasks to be completed.

5. The method of claim 4 wherein said waiting for their extracted tasks to be completed means the extracted tasks have said memory queries for writable access and the next tasks in the corresponding queues have said memory queries for writable access.

6. The method of claim 4 wherein said waiting for their extracted tasks to be completed means an optional variation when the extracted tasks have said memory queries for read-only access and the next tasks in the corresponding queues have said memory queries for writable access.
